(19) United States
(12) Patent Application Publication
(10) Pub. No.: US 2018/0260548 A1
(43) Pub. Date: Sep. 13, 2018

(54) METHOD FOR MEASURING, CALIBRATING, AND DOCUMENTING A SENSOR BY MEANS OF A COMPUTER

(71) Applicant: Endress+Hauser Conducta GmbH+Co. KG, Gerlingen (DE)

(72) Inventor: Benoit Labrique, Stuttgart (DE)

(21) Appl. No.: 15/886,058

(22) Filed: Feb. 1, 2018

(30) Foreign Application Priority Data
Feb. 1, 2017 (DE) 10 2017 101 959.6

(51) Int. Cl. G06F 21/32; G06F 21/34

(52) U.S. Cl. CPC G06F 21/32; G06F 21/34

(57) ABSTRACT

The present disclosure relates to a method for measuring by means of a sensor, calibrating the sensor, and documenting the data of the sensor by means of a computer, including the steps of connecting the sensor to the computer, starting software on the computer for measurement, calibration, and documentation, and executing an action to be logged. The method includes confirming the action to be logged using at least one biometric feature of a user.

### CROSS-REFERENCE TO RELATED APPLICATION

The present application is related to and claims the priority benefit of German Patent Application No. 10 2017 101 959.6, filed on Feb. 1, 2017, the entire contents of which are incorporated herein by reference.

### TECHNICAL FIELD

The present disclosure relates to a method for measuring by means of a sensor, calibrating the sensor, and documenting the data of the sensor by means of a computer.

### BACKGROUND

Process automation sensors may be connected to a computer directly or by means of a corresponding adapter. On the computer, software runs, with the aid of which the life cycle of the sensor may be administered. This software documents the service life of the sensor with complete traceability. For instance, all changes to the sensor—for instance, of parameters—may thus also be documented automatically. The software also turns the computer into a measurement device to which up to four sensors may be connected in parallel, for example. Measurement data may additionally be stored and exported. Such software is distributed by the applicant under the name, “Memobase Plus.”

For many actions—for instance, changing parameters of the sensor, opening certain menus, displaying or exporting reports, or starting a calibration or a measurement—certain legal requirements (for instance, FDA Title 21 CFR Part 11 in the USA) require that these be logged. In addition to this, these must be confirmed with a password. It may then happen that the user must repeatedly input his password over the course of a minute to be allowed to implement the aforementioned actions. This is laborious for the user and possibly leads to the situation that as simple a password as possible is chosen so that the time cost is minimized.

### SUMMARY

The present disclosure is based upon the aim of improving the user-friendliness for the user of software for sensor administration.

This aim is achieved by a method comprising the steps of: connecting the sensor to the computer; starting software on the computer for measurement, calibration, and documentation; and executing an action to be logged. The method is characterized in that the action to be logged is confirmed by means of at least one biometric feature of a user.

What should thereby be understood as a “logged action” are, for instance: starting/stopping a measurement by means of a sensor; calibration and/or adjustment of the sensor and documentation of data of the sensor by means of the computer; changing parameters of the sensor; opening certain menus; displaying or exporting reports; specification and establishment of workflows; modifying access rights of coworkers; deactivating sensors or placing them in operation; scanning sensors or measurement samples (for instance, by means of a barcode reader); and assignment of an identification feature to the sensor (so that this may be uniquely associated in the database, e.g., the SAP number).

A few biometric features should first be named.

In one embodiment, the biometric feature is the fingerprint.

In one embodiment, the biometric feature is the palm of the hand.

In one embodiment, a reader that is separate from the computer and can be connected to the computer is used to read the fingerprint or palm of the hand.

In one embodiment, the fingerprint or palm of the hand is read by means of a computer mouse that can be connected to the computer.

In one embodiment, the fingerprint or palm of the hand is read by means of a screen that is integrated into the computer.

In one embodiment, the biometric feature is the vein structure of a hand or finger.

In one embodiment, both fingerprint and the vein structure of a hand or finger are read.

Conformity—for instance, with the cited FDA guideline—may thus be achieved, in principle.

Work can be performed with the administration software without thereby having to accept actual operating disadvantages. Fingerprint scanners—for instance, connected via USB—are available on the market. A direct scanning, e.g., of a fingerprint, by a touchscreen is additionally possible—for example, for unlocking a mobile telephone. The authentication may be performed directly on the screen by the user simply applying his finger to the surface whenever the program requires him to do so. This functionality is implemented in one embodiment such that the fingerprint is monitored automatically in the background on its own during otherwise typical operation, such as accessing a menu, the acquisition of data, or starting a calibration, which occur by pressing a control surface on the screen. A separate requirement of a complete fingerprint scanner for the authentication of the user may thus be omitted in such an embodiment that achieves a detection of the print within a few hundred milliseconds, which enables a smooth operation.

The realization as cited above may take place in a program for the administration of sensors on a standard PC or corresponding tablet; however, it can, naturally, be transferred to similar products that require an ongoing authentication of the user, as in the case of applications conforming to the law (FDA).

Such applications in conformity with the law are additionally considered for smartphones or measuring transducers if they are equipped, in terms of hardware, with a fingerprint scanner or touchscreen with fingerprint recognition.

In one embodiment, the biometric feature is a feature of the eye—in particular, the iris or the retina.

In one embodiment, the biometric feature is the geometry of the face.

In one embodiment, the biometric feature is the voice.

In one embodiment, the biometric feature is the typing behavior on the computer.

In one embodiment, the biometric feature is a feature of the ear—in particular, the 2-D or 3-D geometry or its frequency response.

In one embodiment, the biometric feature is identification by means of body scent.

In one embodiment, the action to be logged is confirmed by means of at least one biometric feature of a user, and additionally by means of a smart card. This additionally increases the security.

### BRIEF DESCRIPTION OF THE DRAWINGS

This will be explained in more detail with reference to the following figures. These show:

FIGS. 1A and 1B show a measurement device for the execution of the claimed method in two embodiments; and

FIGS. 2A and 2B show two embodiments of the claimed method.

In the figures, the same features are identified with the same reference characters.

### DETAILED DESCRIPTION

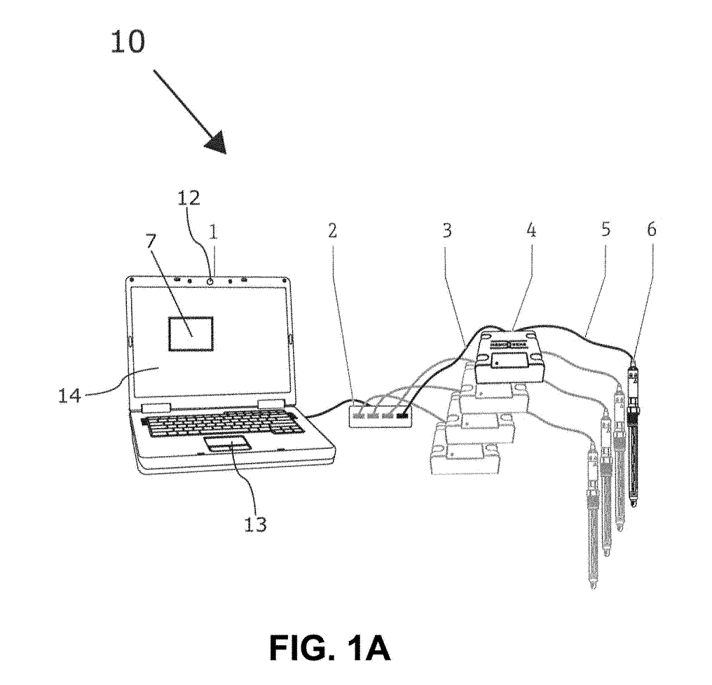

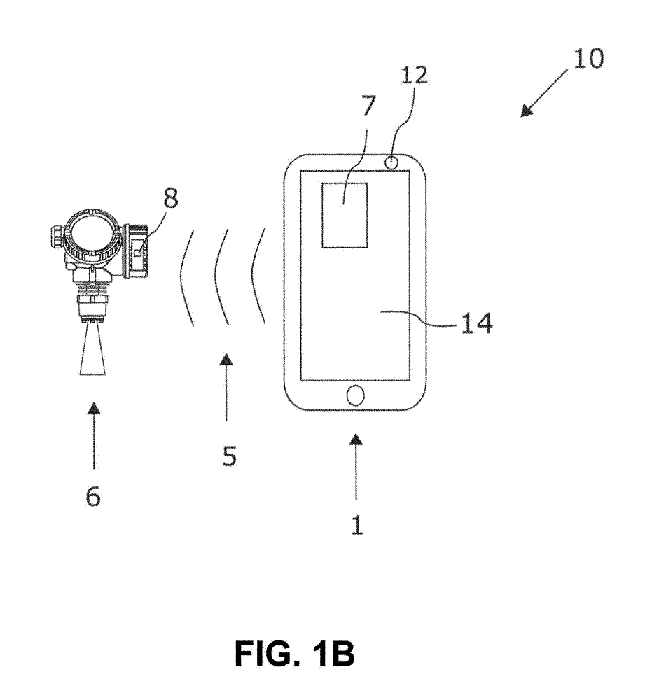

FIG. 1A shows a measurement arrangement 10 that is designed to execute the claimed method. A sensor 6 (here, a pH sensor is shown) is connected to an adapter box by means of a cable 5. Other possible sensors 6 are redox, conductivity, oxygen, and chlorine sensors, for instance. The sensor 6 has an inductive interface. The cable 5 has an inductive interface that is complementary to this. The applicant sells such sensors under the name, “Memosens.”

The cable 5 (in general, a “connection”) is connected to the right of the connection box 4, and therefore has the sensor 6 as an input. Connected to the left side of the connection box 4 is a cable 3 (in general, an additional “connection”). The cable 3 is designed as a USB cable. The connection box 4 thus serves as a transducer between the sensor cable and the USB cable. Since the cable 3 is designed as a USB cable, this may be connected directly to a computer 1. However, depicted between them is a hub 2 that, if applicable, may be omitted.

The computer 1 is, for instance, a PC or a tablet with corresponding hardware inputs, e.g., a USB port. A program 7, which will be discussed in more detail further below, runs on the computer.

FIG. 1B shows an alternative embodiment. The computer 1 is thereby designed as a mobile telephone 1, smartphone, or tablet. The connection 5 to the sensor 6 takes place wirelessly—for instance, by means of Bluetooth, e.g., Bluetooth Low Energy. For this, the sensor 6 comprises a corresponding wireless module 8. In this example, the sensor 6 is designed as a fill-level measurement device. Additional possible sensors are flow rate, temperature, or limit-level sensors. Several sensors 6 may also be connected wirelessly to the mobile telephone 1. A program/app 7, which will be discussed in more detail further below, runs on the smartphone.

The program/app 7 can execute at least one or more of the following functions:
Measurement: measuring, including measurement graphing and sample description
Calibration: multiple calibration methods and testing equipment administration
Sensors: adjustment, administration, status, and information
Reports: database viewing, report generation, and export function

Each sensor can be read out separately. In the program/app 7, sensor type, order root, serial number, and measuring point designation, for instance, can be displayed.

Legal requirements, but also the preference of users, require that certain changes in the program be personally confirmed by means of a password of the user. In this context, these are referred to as “actions to be logged.” Examples of these are: starting/stopping a measurement by means of a sensor; calibration and/or adjustment of the sensor and documentation of data of the sensor by means of the computer; changing parameters of the sensor; opening certain menus; displaying or exporting reports; specification and establishment of workflows; modifying access rights of co-workers; deactivating sensors or placing them in operation; scanning sensors or measurement samples (for instance, by means of a barcode reader); or assignment of an identification feature to the sensor (so that this may be uniquely associated in the database—for example, the SAP number).

Alternatives to the use of a password, viz., the use of biometric features of the user, are claimed.

For this, the computer 1 is connected to a biometric sensor 9. In one embodiment, the biometric sensor 9 is designed as a sensor separate from the computer 1. For instance, the sensor 9 is connected to the computer 1 by means of USB. One example of such a sensor is a fingerprint scanner. Fingerprint scanners are easily available and may be integrated into the program 7 by means of corresponding SDK's (software development kits).

Smart cards are not desirable as a primary identification feature, since a user might forget these at his writing desk, and someone else could misuse them, such that smart cards can at most be used as an additional hurdle, i.e., as a two-factor authentication.

The palm of the hand may be an additional biometric feature.

The vein structure of the hand or a finger may be an additional biometric feature.

These may respectively be read by means of the external biometric sensor 9.

Fingerprint, palm of the hand, or vein structure may also be read by means of a computer mouse 13, if the mouse 13 is accordingly designed for this. The mouse 13 then serves as the biometric sensor 9. The touchpad of a computer may also be used accordingly. Accordingly, the right mouse button might be equipped with a corresponding sensor, for example.

Various methods may also be combined—for instance, the fingerprint with the vein structure. Corresponding hardware is already available on the market.

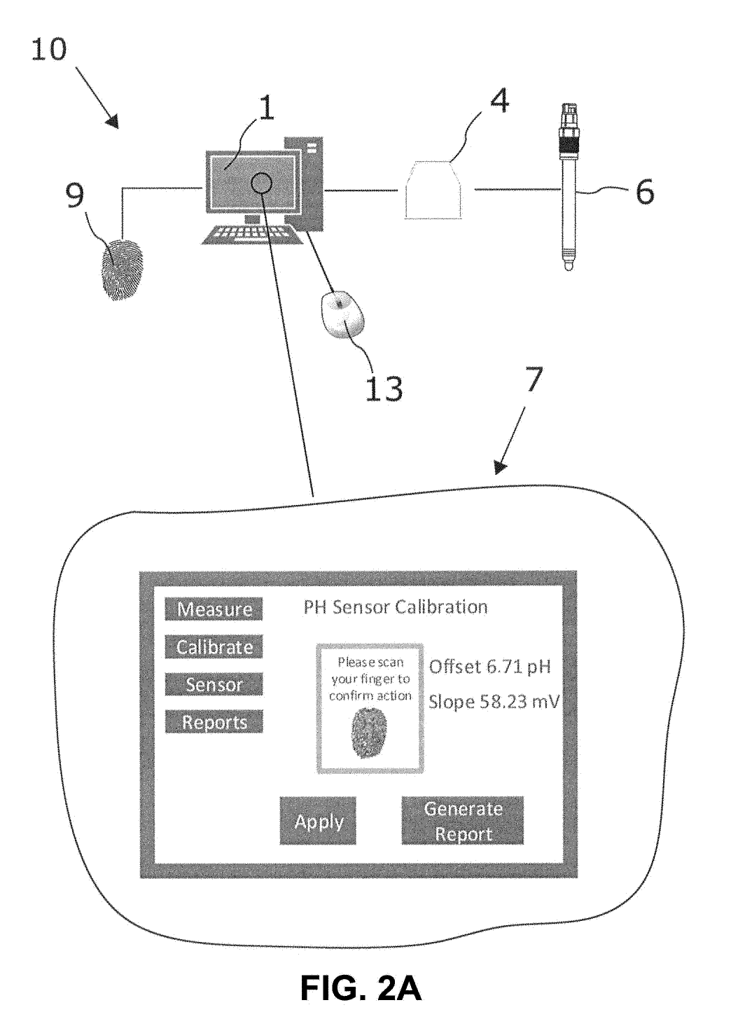

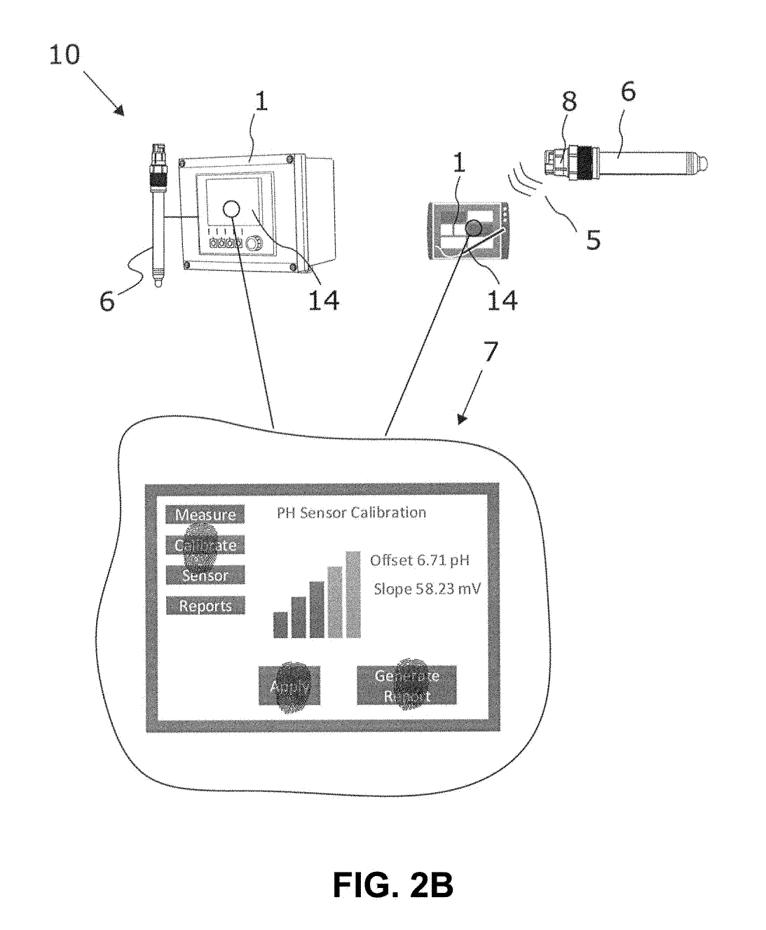

FIG. 2A shows an arrangement 10 having the biometric sensor 9 described above and the mouse 13. The arrangement shown in FIG. 2A otherwise essentially corresponds to that of FIG. 1A. In FIG. 2A, a screenshot of the program 7 already mentioned above is depicted with the reference numeral 7. The main functions (on the left side) that were likewise addressed above, as well as the offset or increase during the calibration, are visible. The user is prompted to place his finger on the biometric sensor 9 to execute an action to be authorized.

In one embodiment, the biometric sensor 9 is integrated into the computer 1. The computer 9 thus comprises a touchscreen 14 that is designed to read the fingerprint. As a computer 1, the PC may comprise such a touchscreen 14, but the embodiment of the computer 1 as a smartphone or tablet also comprises such a touchscreen. The hand structure or vein structure may also be detected accordingly.

The authentication or the confirmation of a change in the program 7 is performed directly on the screen by the user simply applying his finger to the surface 14 whenever the program 7 requires him to do so. This functionality might even be implemented cleverly so that the fingerprint is monitored automatically in the background on its own during otherwise typical operation, such as entering a menu, the acquisition of data, or starting a calibration, which occur by pressing a control surface on the screen. A separate request to the user for authentication would thus be omitted entirely. Fingerprint scanners achieve a detection of the print within 300 ms, which enables a smooth operation.

FIG. 2B shows essentially the same arrangement 10 as FIG. 1B. In addition to this, an embodiment is visible on the left side. A sensor 6 is thereby connected to a transmitter. The transmitter is thereby the computer 1. Transmitters made from measuring transducers are cited. A measuring transducer transduces an input value into an output value according to a fixed relation. Measuring transducers have significant importance in all fields of engineering—in particular, in automation, control, and regulation technology. The transmitter 1, like the tablet 1 depicted on the right side of FIG. 2B, comprises a touchscreen 14 on which biometric features such as fingerprint, vein structure, or hand print may be read. A screenshot of the program described above is depicted, with the reference numeral 7. The user is thereby prompted to confirm a specific action via fingerprint. Since the user directly types on the corresponding area on the touchscreen 14, the fingerprint is read simultaneously, and the corresponding action is thus authenticated.

Alternatively, an iris scanner would be conceivable. An additional alternative is a retina scanner. Another alternative is 2-D/3-D face recognition. For these methods, a camera 12 is used that may be integrated into the computer 1.

An additional possibility is voice recognition.

An additional possibility is to analyze the typing behavior on the computer. What is measured with typing behavior is the behavior of a user when typing on a keyboard. A user may be identified (recognized) or authenticated on the basis of the measured properties.

An additional possibility is the use of the ear as a biometric feature. Either the ear as such may be optically detected (in 2-D or 3-D), similar to iris recognition, or the frequency response of the ear is determined. The camera 12 may be used for the first cited option. For the second cited option, a separate biometric sensor 9 is connected to the computer.

An additional possibility is body scent recognition. The characteristic human scent is thereby detected by means of an external sensor 9. The wearing of perfume or deodorant plays no significant role in the detection. The body scent is individual to each person and can be determined without any problem, even through clothing.

Of course, the various biometric recognition methods may be combined with one another to make the method even more secure.

Claimed is:

1. A method for measuring using a sensor, calibrating the sensor, and documenting the data of the sensor using a computer, the method comprising:
connecting the sensor to the computer;
starting software on the computer for measurement, calibration and documentation; and
executing an action to be logged, wherein the action to be logged is confirmed by means of at least one biometric feature of a user.

2. The method of claim 1, wherein the at least one biometric feature is a fingerprint of the user.

3. The method of claim 2, wherein a reader separate from and connected to the computer is used to read the fingerprint of the user.

4. The method of claim 3, wherein the reader is a computer mouse connected to the computer.

5. The method of claim 3, wherein the reader is at least a portion of a screen that is integrated into the computer.

6. The method of claim 1, wherein the at least one biometric feature is a palm of a hand of the user.

7. The method of claim 6, wherein a reader separate from and connected to the computer is used to read the palm of the hand of the user.

8. The method of claim 7, wherein the reader is a computer mouse connected to the computer.

9. The method of claim 7, wherein the reader is at least a portion of a screen that is integrated into the computer.

10. The method of claim 1, wherein the at least one biometric feature is a vein structure of a hand or finger of the user.

11. The method of claims 1, wherein the at least one biometric feature includes a fingerprint and a vein structure of a hand or finger of the user, which are read.

12. The method of claim 1, wherein the at least one biometric feature is a feature of an iris or a retina of the user's eye.

13. The method of claim 1, wherein the at least one biometric feature is a facial geometry of the user.

14. The method of claim 1, wherein the at least one biometric feature is a voice of the user.

15. The method of claim 1, wherein the at least one biometric feature is a typing behavior of the user on the computer.

16. The method of claim 1, wherein the action to be logged is confirmed using the at least one biometric feature of a user and a smart card associated with the user.
